(19) United States
(12) Patent Application Publication
(10) Pub. No.: US 2014/0170604 A1
(43) Pub. Date: Jun. 19, 2014

(54) COLORING SYSTEM AND MANUFACTURING PROCESS FOR ARTIFICIAL COVERING STONES

(71) Applicants: Robert Daoust, Boucherville (CA); Luciano Posada, Montreal (CA); Yves Chagnon, Val-David (CA)

(72) Inventors: Robert Daoust, Boucherville (CA); Luciano Posada, Montreal (CA); Yves Chagnon, Val-David (CA)

(73) Assignee: OLDCASTLE BUILDING PRODUCTS CANADA INC., Saint-John, NB (CA)

(21) Appl. No.: 14/236,043

(22) PCT Filed: Jul. 19, 2012
(86) PCT No.: PCT/CA2012/050494

§ 371 Date: Jan. 29, 2014

Related U.S. Application Data
(60) Provisional application No. 61/513,183, filed on Jul. 29, 2011.

(51) Int. Cl. G09F 15/00

(52) U.S. Cl. CPC G09F 15/00
USPC 434/98; 29/428

(57) ABSTRACT

A coloring system and a manufacturing process for coloring artificial covering stones are provided. A board layout represents a board of artificial covering stones. Several natural stone color patterns are provided, each being different from one another. The natural stone color patterns are associated with selected artificial stones of the board layout. Graphic parameters represent the natural stone color and are converted into coloring instructions. A conveyor conveys the board of artificial covering stones, and a positioning system determines respective positions of the artificial covering stones of the board, relative to a reference position. An in-line coloring device colors the artificial covering stones with the natural stone patterns, according to the coloring instructions and to the positions of the artificial stones. The selected artificial stones colored by the system are thus different from other stones of the board, and have a distinct, natural random-look.

### CROSS-REFERENCE TO RELATED APPLICATIONS

This application is a national stage application under 35 U.S.C. 317 of Inter-national Patent Application Serial No. PCT/CA2012/050494, entitled “COLORING SYSTEM AND MANUFACTURING PROCESS FOR ARTIFICIAL COVERING STONES,” filed Jul. 19, 2012, which claims priority from U.S. Patent Application No. 61/513,183, filed Jul. 29, 2011, the disclosures of which are incorporated herein by reference.

### FIELD OF THE INVENTION

The present invention relates to the field of artificial covering stones. More particularly, it concerns systems and methods for coloring artificial covering stones.

### BACKGROUND

Artificial covering stones made of concrete are well-known to lay out pavements or covering wall surfaces on residential or commercial properties, for example defining the surface of walkways or patios. Such artificial stones have the advantage to be relatively inexpensive to make as opposed to natural carved flagstones, but the resulting pattern is often repetitive or has what is called in this field an unnatural “linear line effect”. Great efforts have been made to design artificial covering stones which provide a more natural look, while still retaining the ease of their manufacture. It is worth mentioning that the expressions “artificial covering unit”, “artificial stone” and “artificial flagstone” are used throughout the present description without distinction to define a manufactured unit used as a paving or as a building material.

For example, a lot of attention was put in the choice of the shape of the artificial covering stones, and more particularly in order to provide the top or exposed surface of the stones with an irregular finish. Aging apparatuses were also developed to give the stones with a rustic, rough, old-looking surface.

As for the color of the artificial stones, they are chosen to correspond to the most predominant colors within natural stones. The current technique for coloring artificial stones consists of mixing several batches of concrete mixture, generally from two to six, each batch containing pigments of a given color, for example grey, beige or brown. Care is put into mixing the colored concrete batches, such as to create natural shades of colors within the stones.

Natural stones come in an infinite variety of colors, shades, tones, textures and veining patterns. The veins in a stone are often of a color different than the main predominant colors of the stone. The veins are randomly distributed within the stone, adding to its uniqueness and cachet, and no two blocks of natural stone are ever identical in appearance.

While the currently manufactured artificial covering stones are close-enough imitations of natural stones, connoisseurs and experts are still able to tell them apart from natural stones. Reproducing random, natural characteristics of stones, such as veins, shades and tones of colors in manufactured covering stones would certainly provide them with an even more natural, unique aspect.

There are systems for reproducing natural patterns over artificial covering material. For example, artificial wood veneers are made by printing wood figures onto semi-rigid sheets using large rolls which are used as stamps. The problem with such techniques is that the pattern repeats itself over time and the same figure or design appears on several stones of the same manufacturing lot. When the veneers are used to cover a wall surface, one can detect repeated patterns over the covered wall.

Also known to the Applicant are U.S. Pat. No. 7,736,557 (EVANS et al.), US 2008/0294272 (BITTNER et al.), US 2010/0068481 (BAUER), U.S. Pat. No. 6,037,015 (DOS SANTO SIMOES et al.) et U.S. Pat. No. 5,993,551 (HAHN).

EVANS teaches a method and an apparatus for constructing and installing roofing tiles having an arbitrary design of colors, patterns, textures and the like. One drawback of the apparatus and the method taught by EVANS is that they are not meant to be integrated to a manufacturing assembly line, and are not adapted for a high-volume manufacturing industry, such as artificial covering stones.

BITTNER teaches a process for randomly patterning carpet tiles so that when installed, the covered floor provides an overall random appearance. However, BITTNER is not concerned with provided a natural look to the carpet tiles. In addition, the process described is to be performed by existing patterning machines specifically used for the application of dye on textile substrates.

HAHN describes an apparatus and a method for randomly spraying patterns on clay tiles using multiple oscillating spray nozzles. While HAHN allows to create random color patterns on clay tiles, it does not allow to choose which pattern is to be applied on which tiles.

In addition, EVANS, BITTNER and HAHN are not adapted for manufacturing processes for which the units manufactured are conveyed on pallets or boards containing several units or different sizes and shapes.

Thus, there is still a need for a coloring system and process that would help providing a long sought after real natural random look to artificial covering stones while being easy to implement in a manufacturing plant and process, at a reasonable cost.

### SUMMARY OF THE INVENTION

Hence, in light of the aforementioned, there is a need for an improved system and method which, by virtue of their design and components, would be able to overcome some of the above-discussed prior art concerns.

According to an aspect of the present invention, there is provided a coloring system for coloring artificial covering stones. The system comprises a memory for storing a board layout representing a board of artificial covering stones; and for storing several natural stone color patterns, each of the patterns being different from one another. The system comprises a display for displaying the board layout and the natural stone patterns and an input for receiving instructions to select at least some of the stones of the board layout, and to associate the natural stone color patterns with selected artificial stones of the board layout. The system also comprises generating means for generating graphic parameters representative of the natural stone color patterns associated with the selected stones of the board layout and converting means for converting said graphic parameters into coloring instructions. A conveyor conveys the board of artificial covering stones and a positioning system determines respective positions of the artificial covering stones of the board, relative to a reference position. The system comprises an in-line coloring device for coloring the artificial covering stones of the board conveyed by the conveyor with the natural stone patterns, according to the coloring instructions and to the positions of the artificial stones. The selected artificial stones colored by the system are thus different from other stones of the board, and they have a distinct, natural random-look.

In one embodiment, the memory contains data representative of at least one of a line, a stroke, a shade and a curve, said natural stone patterns being selected from said data.

In one embodiment, the input comprises at least one of a keyboard, a tablet, a mouse or a touchscreen.

In one embodiment, the generating means comprises a memory containing a generating software function and a graphic parameter data structure; and a processor, for executing said generating software function and for populating said graphic parameter data structure with the graphic parameters, based on said natural stone color patterns associated with the selected stones of the board layout.

In one embodiment, the graphic parameter data structure stored on the memory of the generating means contains data representative of at least one of: a color code, a degree of opacity, a degree of transparency, a width, a length, a radius of curvature, a pixel value, a coordinate, and an artificial covering stone identifier.

In one embodiment, the converting means comprises: a memory containing a converting software function and a coloring instruction data structure; and a processor, for executing said converting software function and for populating said coloring instructions data structure based on said graphic parameters.

In one embodiment, the positioning system comprises a vision system for determining the respective positions of the artificial covering stones on the board, and a memory for storing said positions.

In one embodiment, the processor executes the converting software and populates the coloring instructions data structure based on predetermined coloring parameters associated to the in-line coloring device.

In one embodiment, the coloring device comprises a paint nozzle for spraying paint on the artificial covering stones, a displacement system for displacing the paint nozzle; and a controller for controlling the paint nozzle and the displacement system.

In one embodiment, the coloring instructions data structure stored on the memory comprises data representative of at least one of: paint cartridge identifiers, an initial position of the paint nozzle when starting to spray, a displacement vector specifying a 3D trajectory to be followed by the paint nozzle, a speed, an acceleration, a number of passes, a flow rate, a pressure, a nozzle angle and a nozzle aperture.

In one embodiment, the in-line coloring device comprises several paint containers.

In one embodiment, the paint containers are containers containing paint which is polymerizable by UV rays.

In one embodiment, the system further comprises an in-line polymerization station located downstream of the in-line coloring device, for polymerizing the paint applied on the artificial covering stones by the in-line coloring device.

In one embodiment, the system further comprises a comparing system, the comparing system including means to compare the selected artificial covering stones colored by the coloring device with a reference layout, means to correlate a deviation thereof; and an output to emit a signal representative of said deviation.

In one embodiment, the displacement system is a robot able to move the paint nozzle in X, Y and Z directions.

The invention concerns a manufacturing process for coloring selected artificial covering stones. The process comprises the steps of:
selecting at least some of the artificial covering stones from a board layout;
associating natural stone color patterns, each of the patterns being different from one another, with the selected artificial covering stones;
generating graphic parameters based on an association performed in the previous step;
converting said graphic parameters into coloring instructions;
conveying the board of artificial covering stones;
determining respective positions of the artificial covering stones on the board conveyed relative to a reference position;
coloring in-line the artificial covering stones of the board conveyed with the respective natural stone patterns, according to the coloring instructions,
thereby providing each of the stones of the board with a distinct, natural random-look, the selected artificial stones colored by the system thereby being different from other stones of the board, and having a distinct, natural random-look.

In one embodiment of the process, the natural stone color patterns comprises at least one of: a line, a stroke, a shade and a curve.

In one embodiment, the graphic parameters comprise at least one of: a color code, a degree of opacity, a degree of transparency, a width, a length, a radius of curvature, a pixel value, a coordinate, an artificial covering stone identifier.

In one embodiment, the step of converting the graphic parameters into coloring instructions comprises converting coloring parameters into coloring instructions.

In one embodiment, the manufacturing process comprises a step of determining the respective heights, widths and lengths of the selected artificial covering stones.

In one embodiment, the step of converting the graphic parameters into coloring instructions comprises populating a coloring instructions data structure based on the graphic parameters and on the positions of the artificial covering stones.

In one embodiment, the coloring instructions are based on the graphic parameters and on the positions of the artificial covering stones.

In one embodiment, the paint nozzle is moved over the board along X, Y and Z directions.

In one embodiment, the process further comprises a step of polymerizing paint applied on the selected artificial stones.

In one embodiment, the process comprises a step of comparing the artificial covering stones colored with the stones of a reference layout, and of providing an indication of the deviation between the colored stones and the reference layout.

In one embodiment, the paint nozzle is displaced along 3-dimensional trajectories, each trajectory corresponding to one of the natural stone patterns.

Advantageously, the systems and method of the present invention allow an in-line manufacturing of natural, random-look artificial covering stones. The patterns can include for example veins and shades of color which were up to now difficult to reproduce with existing systems and techniques. Another advantage of the system is that the stones within a lot can differ from one another, and each lot manufactured can include unique, random-look stones. Yet another advantage of the invention is the possibility to color the stones with a larger variety of colors, different than the ones used to color the concrete forming the stones.

### BRIEF DESCRIPTION OF THE DRAWINGS

Other objects, advantages and features of the present invention will become more apparent upon reading the following non-restrictive description of embodiments thereof, given for the purpose of exemplification only, with reference to the accompanying drawings in which:

FIG. 1 is a window of a graphic interface display of the coloring system, according to an embodiment of the invention.

FIG. 2 is a window of a graphic interface display of the coloring system, according to an embodiment of the invention.

FIG. 3 is a window of a graphic interface display of the coloring system, according to an embodiment of the invention.

FIG. 4 is a window of a graphic interface display of the coloring system, according to an embodiment of the invention.

FIG. 5 is a window of a graphic interface display of the coloring system, according to an embodiment of the invention.

FIG. 6 is a window of a graphic interface display of the coloring system, according to an embodiment of the invention.

FIG. 7 is a window of a graphic interface display of the coloring system, according to an embodiment of the invention.

FIG. 8 is a window of a graphic interface display of the coloring system, according to an embodiment of the invention.

FIG. 9 is a block diagram of a coloring system, according to an embodiment of the invention.

FIG. 10 is a block diagram of a coloring system, according to another embodiment of the invention.

FIG. 11 is a side view of a coloring system within its environment, according to an embodiment of the invention.

FIG. 12 is a top view of what is shown in FIG. 11.

FIG. 13 is a top schematic view of a board of colored stones exiting the coloring system of FIG. 11.

FIG. 14 is a side perspective view of an artificial covering unit colored by the coloring system of FIG. 11.

FIG. 15 is a flow chart of steps of the method, according to an embodiment of the invention.

### DESCRIPTION OF EMBODIMENTS

In the following description, similar features in the drawings have been given similar reference numerals. In order to preserve clarity, certain elements may not be identified in some figures if they are already identified in a previous figure.

In the present description, an artificial covering stones is a block or a unit manufactured by man and used for covering walls or for paving floors, patios, sidewalks and the likes.

Generally stated, the system of the present invention allows to generate graphic parameters representative of a natural stone pattern and to convert these graphic parameters into coloring instructions for use by a coloring device.

The coloring system allows coloring selected artificial covering stones conveyed on a board, so that each of the selected artificial stones on the board of stones is different from one other stones of the boar, and has a distinct, natural random-look.

The system includes a graphic user interface; generating means to generate graphic parameters from the natural stone patterns associated to selected artificial stones; a conveyor; a positioning system; converting means to convert the graphic parameters into coloring instructions, and an in-line coloring device.

The system allows a user to create several natural stone color patterns to be applied on selected artificial covering stones that are part of a board layout, so as to provide them with a more natural aspect. The board layout represents a board, or pallet, for transporting several artificial covering stones. The user of the graphic user interface can be an operator, a designer, a product manager, etc. It can also be considered to create the patterns randomly, with a software application.

The natural stone pattern can take the form of a line, a stroke, a shade or a curve of a given color, or a combination of some or all of these elements, in order to recreate visual characteristics of natural stones, such as veins or natural variations of colors and shades. The natural stone pattern can include one or several lines, of one or more colors. The board layout, the selected artificial stones and the natural stone patterns are stored on a memory that is part of the graphic user interface.

The pattern can be created through the graphic interface, with the use of an input, for example a mouse, a keyboard, a drawing tablet, a touch screen, etc. The graphic interface displays an uncolored artificial covering unit, on which the user can add lines, strokes, and curves of different colors, shades, thicknesses, and opacity, such as to provide the unit displayed with a natural stone pattern. The input, for example the mouse of the graphic user interface, allows receiving instructions from a designer to generate the natural stone patterns, to select the stones on which the pattern(s) are to be applied, and to associate the natural stone color patterns with the selected artificial stones of the board layout.

For each of the natural stone color pattern created, the software application stores in memory a data structure containing graphic parameters representative of the natural stone color pattern and of the artificial stones on which the pattern(s) is(are) to be applied, or in other words, the selected artificial stones. For a given pattern, for example a black curved line, graphic parameters will be generated and stored by the software application in a corresponding data structure, such parameters include the color, the radius of curvature, length of the line, the position or coordinate of the line on the unit, the position of the unit on the board, the thickness of the line, its opacity, etc.

The board layout represents a pallet of artificial covering stones conveyed by the conveyor of a manufacturing line. The positioning system determines the position of each of the artificial stones in the board relative to a reference position. Alternatively, it is possible to determine the position of the board, and to deduct the position of each of the stones based on the board layout.

Based on the graphic parameters and on the position the stones, the converting means converts or transform this information into coloring instructions for use by the coloring device. The coloring instructions can include for example the paint color or combination of paint colors to be used by a coloring tool, the distance of the coloring tool from the stone when applying paint, the speed at which the color must be applied, the number of passes the coloring tool must make over the stone, the flow rate and duration for which the coloring tool projects the paint, the trajectory to be followed over the board, etc.

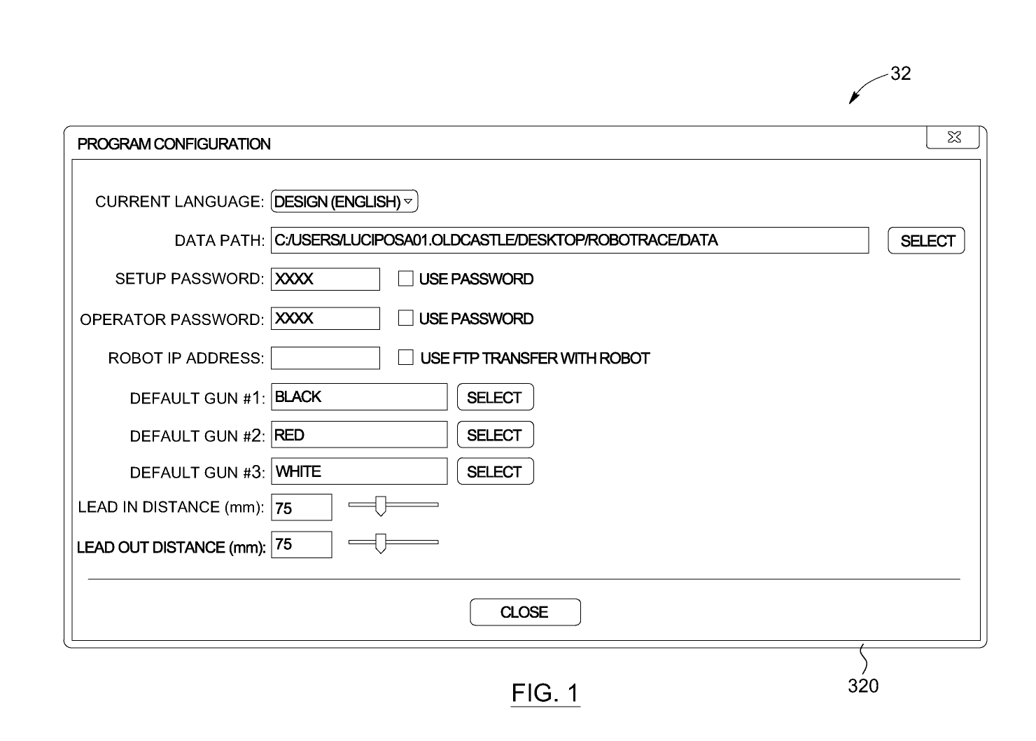

With reference to FIGS. 1 to 14, the system and method for coloring selected artificial covering stones of a board of stones with a distinct and natural look will be described.

Referring to FIG. 1, a user of the graphic interface 32 logs in through a configuration window 320, enters his password, and selects the source of data to be used. The data can include for example previously created natural stone color patterns, board layouts of artificial covering units, dimensions for each of the artificial covering units, and the likes. The graphic user interface 32 is part of a software application and can be executed on any type of device provided with a processor and a memory, such as a computer, a server, a laptop, a portable tablet, etc. The user can select default or predominant colors to be used for the creation of natural look patterns, and lead in and lead out distance of the coloring tool from the stones when projecting paint on a given stone.

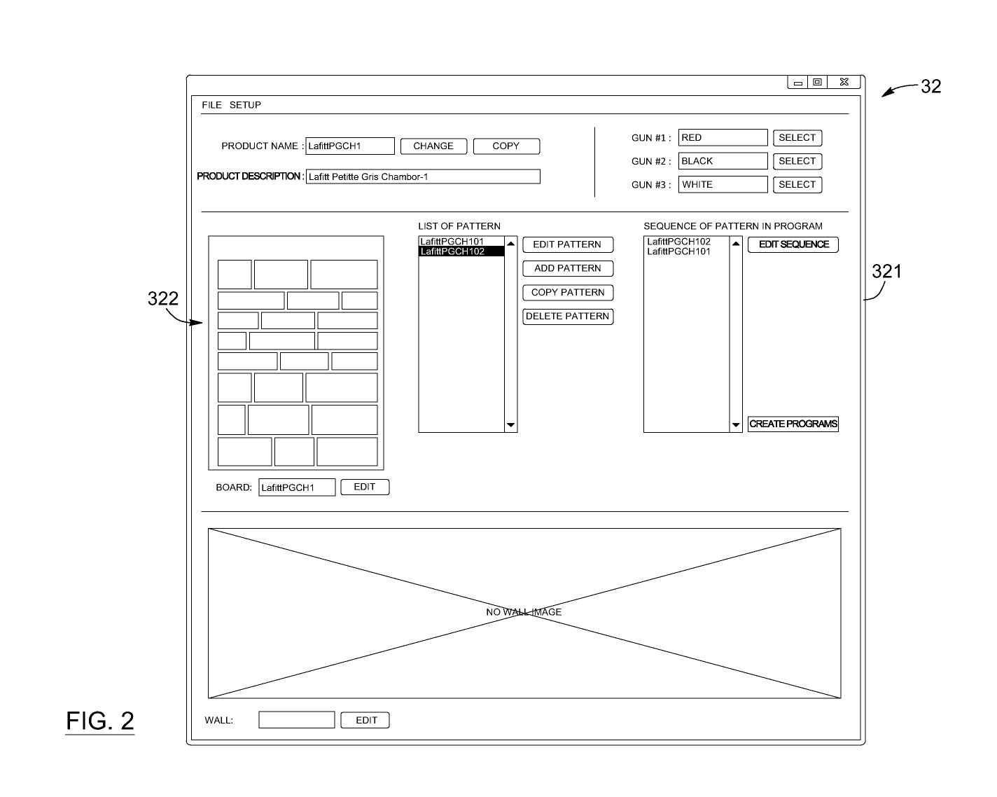

Now with reference to FIG. 2, the graphic user interface 32 includes an editing product window 321, presenting a board layout of artificial covering stones, as it appear when entering the enclosure of the coloring device. The board layout 322 represents a pallet supporting several artificial covering stones, when they are conveyed on the manufacturing line toward the coloring device. This window 321 allows selecting one or several patterns from a first list of pre-existing natural stone color patterns. The patterns selected can be modified, copied, added or deleted to a second list, for determining the order or sequence in which these patterns will be applied on the stones.

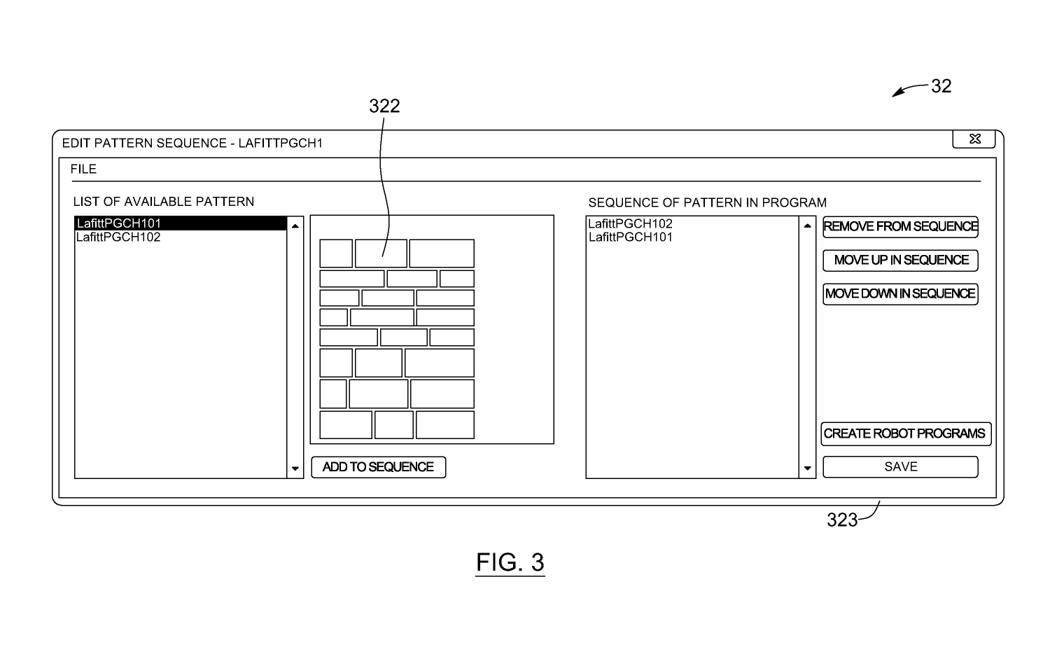

Referring to FIG. 3, the graphic user interface 32 includes an editing pattern sequence window 323, through which it is possible to define the pattern sequence during the coloring process. This sequence order can be modified by adding, removing and changing the sequencing of the patterns using the interface illustrated in FIG. 3. The user can also create new patterns instead of using pre-existing ones, as it will be described later in the description. In the case illustrated, two patterns are used so that one the manufacturing line, the boards of stones will be colored alternatively with patterns 101 and 102.

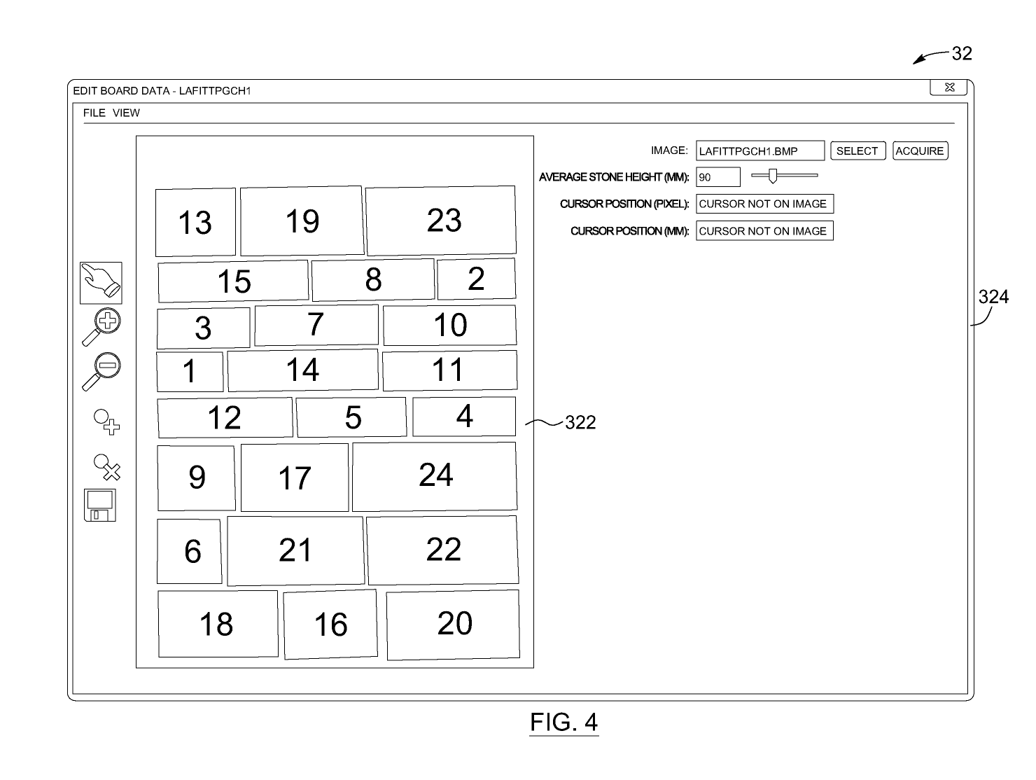

Referring to FIG. 4, a board layout of artificial stones manufactured is shown. The system is able to handle several types of board layouts, as it is common for different types of stones to be manufactured within the same production line. The graphic user interface 32 includes an editing board layout window 324 which allows providing each of the stones on the board layout 322 with an identifier. The average stone height can also be indicated, so as to allow the coloring device to adjust its height accordingly. The average stone height can be entered manually, or can be calculated by the positioning system, which can be a group of sensors, or a vision system, including a 3D camera for example. The image shown through this interface is captured by the vision system. It allows the system to learn new board layouts so that the coloring system can handle boards having various configurations, without having to reconfigure the entire system each time a new product is introduced.

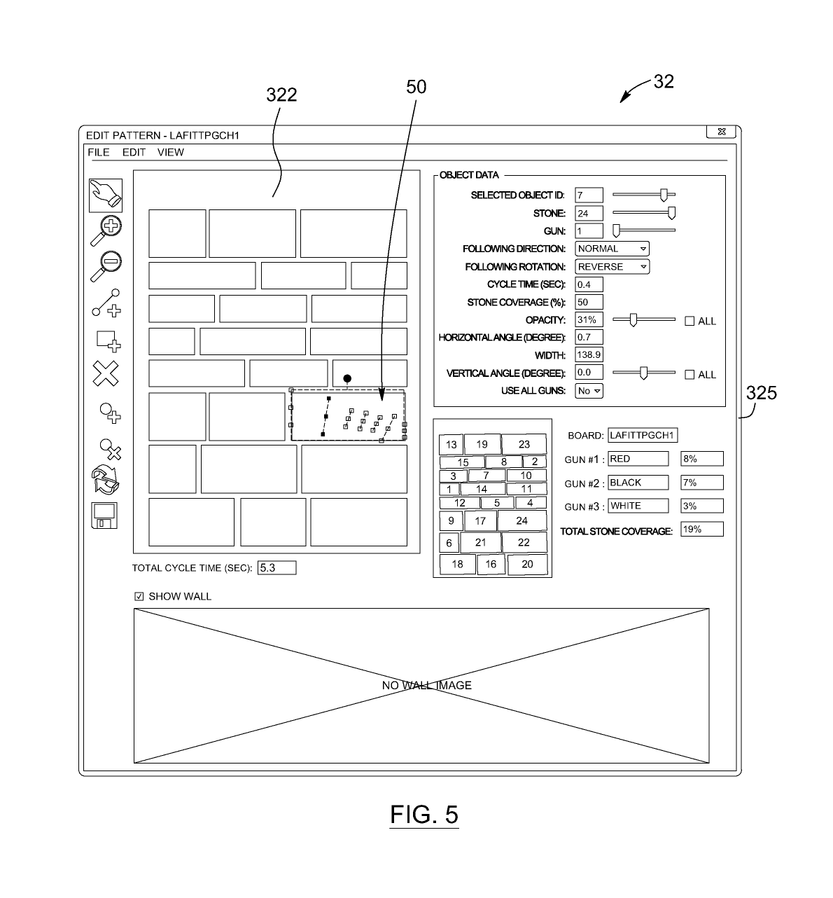

With reference to FIG. 5, the graphic user interface 32 includes an editing pattern window 325. This window 325 allows selecting one, several or all of the stones of the board layout, and also allows creating a natural stone color pattern 50. For each of the stones selected, one or several lines can be created, each having a specific position, color, length, thickness, opacity, angle, etc. As such, one or several patterns can be associated to a selected stone of the board layout. Users instruct the graphic user interface of the selection of the stones and of the association of the patterns related to the selected artificial stones. The input can be for example the mouse and keyboard of a computer, or a touchscreen. This association of patterns and stones is stored in a memory under a given pattern name.

The system includes generating means to generate graphic parameters representative of the natural stone color patterns associated with the selected artificial stones of the board layout. The generating means includes a memory containing a generating software function and a graphic parameter data structure and a processor for executing the software function. When executing the generating software function, the processor populates the graphic parameter data structure based on the natural stone color patterns associated to the selected stones of the board layout.

The graphic parameter data structure contains data representative of a color code, a degree of opacity, a degree of transparency, a width, a length, a radius of curvature, a pixel value, a coordinate, an artificial covering stone identifier, or a combination of several of these elements.

The graphic user interface and the generating means can be part of the same application, sharing the same memory and processor. They can be part of a software application which includes several distributed modules, each performing a specific function.

The system also includes converting means to convert the graphic parameters and the position of the board into coloring instructions. The converting means are typically a converting software function stored on a memory, and executable by a processor. The converting software function can be part of the same system including the graphic user interface, and the generating software, or part of another application.

The converting means includes a memory containing the converting software function and a coloring instruction data structure. The converting software function is executable by a processor. The processor executes the converting software function and populates the coloring data structure based on the graphic parameter and on the position of the conveyed board.

The conversion is done by associating each graphic parameter to physical or mechanical property of the coloring device, which can be, for example, the distance of the coloring tool from the unit, the speed of the coloring tool, the number of passes for coloring the unit, the nozzle angle of the coloring tool, etc.

For example, a thick, black and opaque line to be colored on a selected stone of the board will be translated in coloring parameters which will include the paint color container (black), the gun position when opening and closing its nozzle, the angle of the nozzle when ejecting paint (for example, 30 degrees), the distance of the nozzle from the unit and the flow rate of the nozzle (For example, higher flow rate, closer and slower for a thinner and more opaque trace), the location of the selected unit on the board, etc. This conversion is executed by the processor running the converting software function, and stored within the memory of the computer or of the PLC in one or several coloring instructions data structure(s).

Still referring to FIG. 5, this interface also allows optimizing or maximizing the process of coloring the stones by selecting the order in which the lines of the patterns will be applied, so as to minimize the cycle time required to color the selected stones on the board.

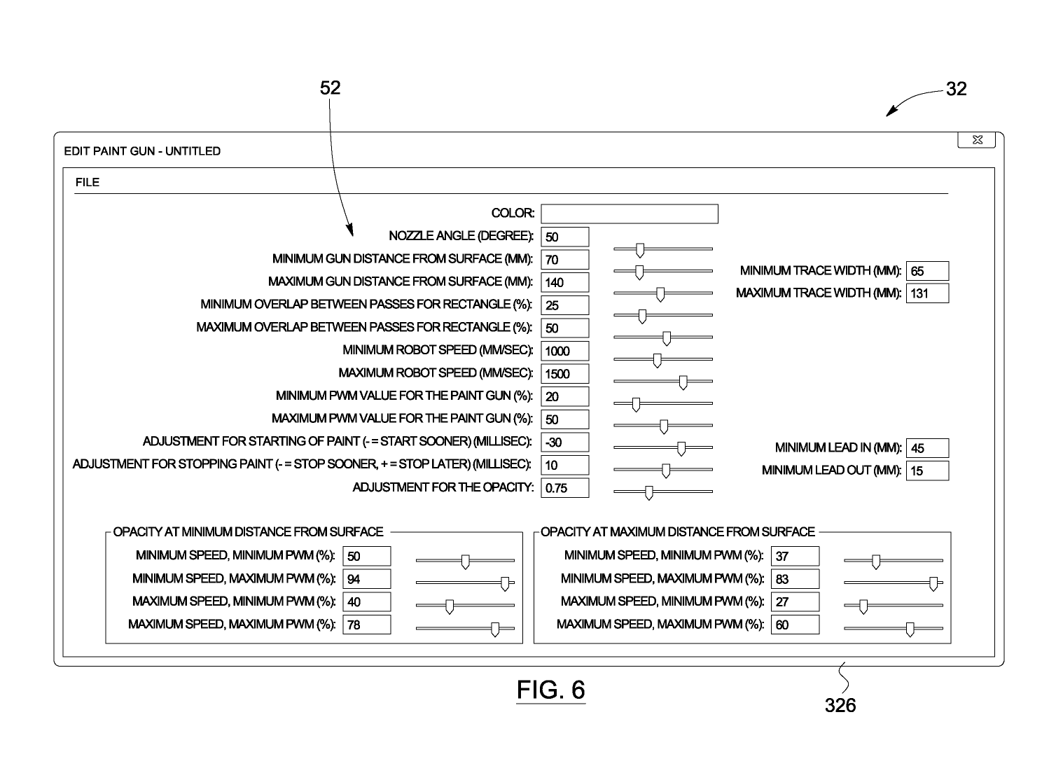

With reference to FIG. 6, this interface 326 allows to modify different coloring parameters according to which the coloring device will work. These coloring parameters are determined for each color and can be adjusted. As it can be seen, the nozzle angle, the distance of the paint gun from the unit, the speed of the gun, the flow of the nozzle, and several other parameters can be adjusted. For example, the coloring parameters 52 can be adjusted if the viscosity of the paint changes. They can also be adjusted if, for example, black lines are to be applied with more intensity. In this embodiment of the system, these coloring parameters and the graphic parameters generated from the natural stone patterns are both used to generate coloring instructions for use by the coloring device. Of course, it can be considered to fix the coloring parameters to pre-set values, without allowing any adjustment. In this case, the system uses pre-set coloring parameters and the graphic parameters to generate coloring instructions.

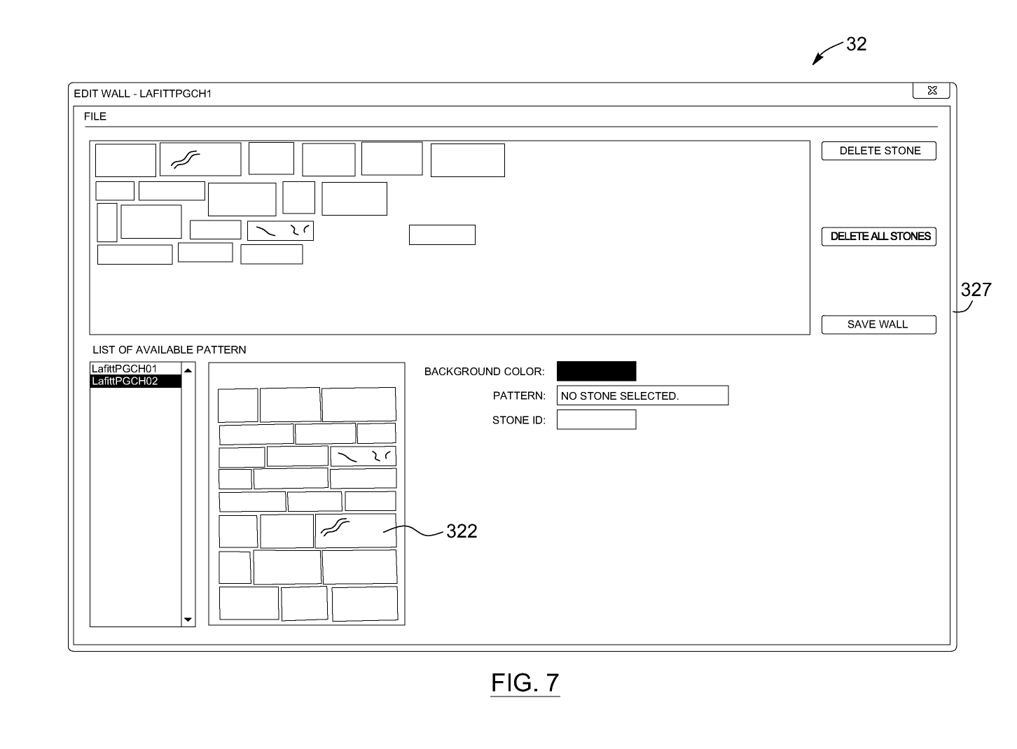

Now with reference to FIG. 7, the graphic user interface can include an editing wall window, allowing simulating a surface covered with some of the stones colored with the natural stone color pattern. Such a surface can be, for example, the wall of a building or an outdoor terrace. This window 327 advantageously allows verifying if the patterns created indeed provide a natural look to the surface, and allows adjusting the pattern if required. For example, it can be used to verify if there is a color which is too predominant, or if the different colors are well-balanced.

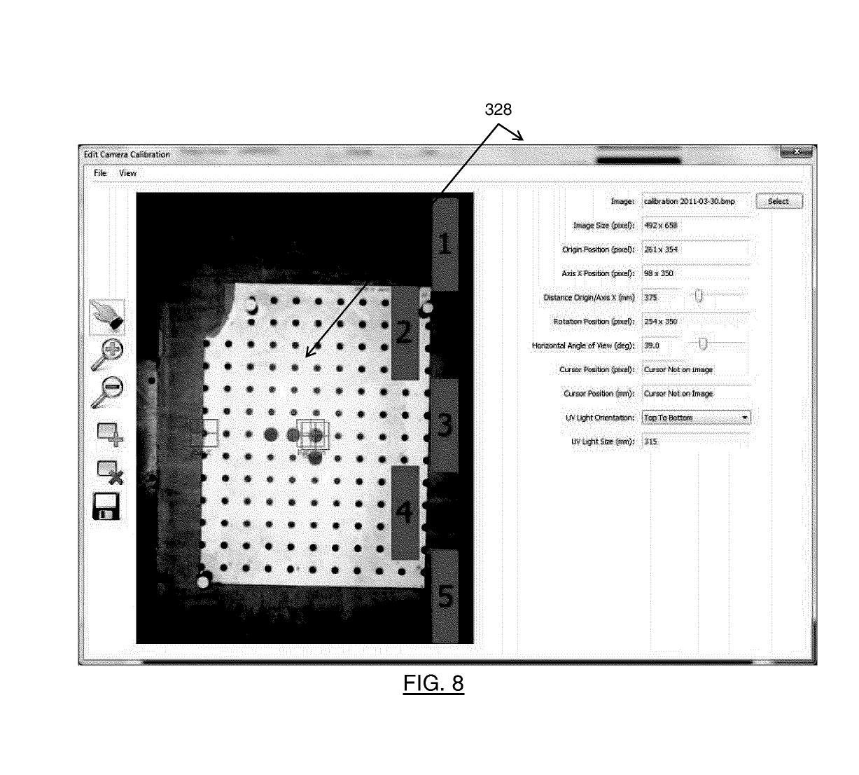

Now turning to FIG. 8, the system can include a calibration system 328 which allows reconciling the position of the cursor within the graphic interface 32 in the coordinate system of the coloring device and with the actual positions of the stones in the conveyed board, in order to reproduce the patterns created on the selected stones. The calibration is done using a calibration grid imaged by the positioning system of the coloring device. In the case where the vision system includes 2D and 3D cameras, the calibration system allows to reconcile both cameras in the same reference system. It also allows establishing the correspondence between pixels and distances; in other words, it allows determining that one pixel represents a surface of 1 mm² for example.

As it can be appreciated, the graphic interface described allows generating graphic parameters representative of natural stone color pattern. The converting means, in this case a converting software application, allows converting the graphic parameters and coloring parameters into coloring instructions, for use by a coloring device. The converting means can include a converting software application, stored on the memory of a server and executable by the processor of the server, for converting the graphic parameters and coloring parameters into coloring instructions. Alternatively, the converting means can also include a programmable logic controller (PLC) which uses the coloring parameters and the position of the stones to generate coloring instructions, destined to the coloring device.

The coloring instructions can be based on coloring parameters stored in a memory, in the form of a data structure. The graphic parameters and coloring parameters are used to generate coloring instructions in order for the coloring device to color the selected stones with the color pattern previously created.

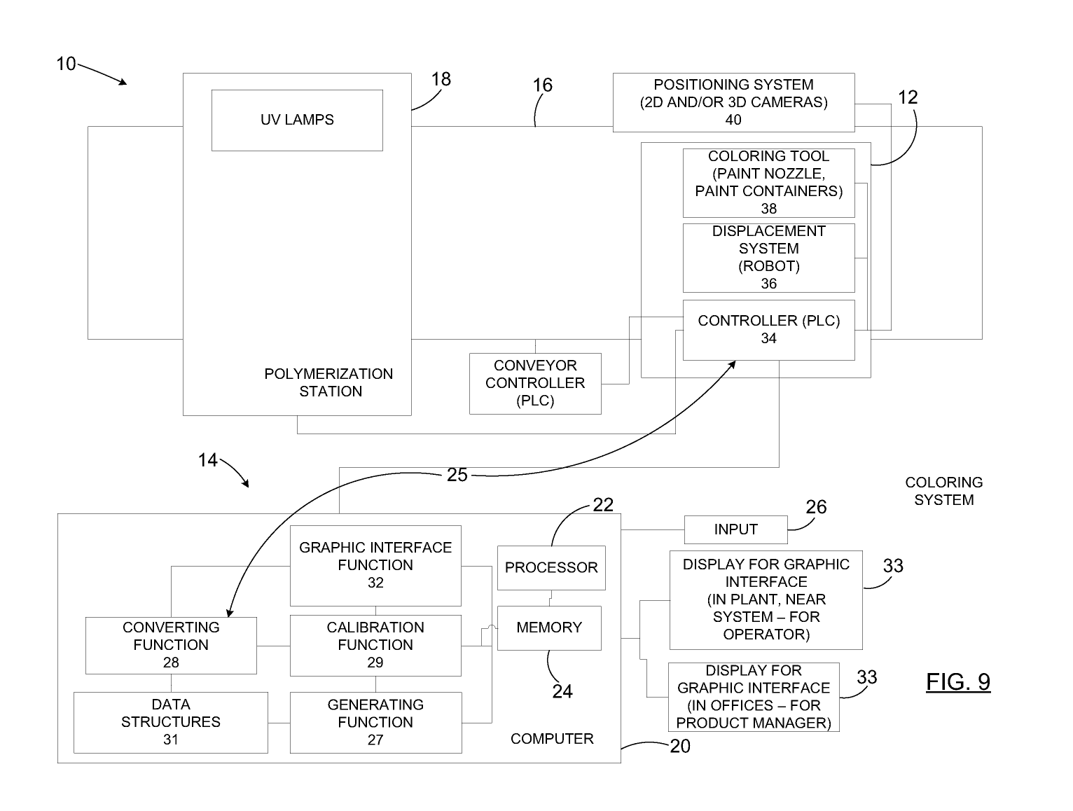

Referring to FIG. 9, the coloring system 10 includes a computer 20 having a memory 24 and a processor 22, at least one display 33, an input 26, generating means 27, converting means 28, a conveyor 16, a positioning system 40, a coloring device 12 and a polymerization station 18.

In this embodiment, the graphic user interface 32, the generating means 27 and the converting means 28 are part of a software application 14 which is run by the computer 20. Of course, in other embodiments, it can be considered to distribute these components on more than one computer/server. The input module 26 can be either one of a keyboard, a mouse, a tablet or a touchscreen, or the combination of one or several of these elements. The board layout and the natural stone patterns are stored in the memory 24. They can be displayed on one of the displays 33, through the graphic user interface 32. The displays 33 can be directly connected to the computer 20, in the surroundings of the coloring device, or remotely, for example on a computer screen located in an office, outside the manufacturing plant, for access by a product manager for example.

As described earlier, a natural stone pattern can be created from scratch or chosen from a list of pre-existing patterns. The generation software function 27 generates graphic parameters representative of the natural stone color patterns associated with the selected stones of the board layout. These graphic parameters are stored in the memory of the computer 20 in graphic parameter data structures, based on the natural stone color patterns and on the selected stones for the board layout. They are then converted by the converting means 25 into coloring instructions for use by the coloring device 12.

In the present embodiment, the converting means 25 includes a software function 28 stored on the computer which converts the graphic parameters into coloring parameters, and another software function stored on a PLC 34, which uses the coloring parameters and the position of the board from the positioning system 40 to generate coloring instructions for use by the coloring device 12. The coloring instructions are stored in a data structure on a memory, the memory being part of either one of computer 20 or the PLC 34.

The coloring device 12 uses the coloring instructions for reproducing the natural stone pattern(s) on selected artificial covering units of the board. The coloring device 12 can include the controller 34, such as a PLC—Programmable Logic Controller; a displacement system, such as a robot; a coloring tool 38, such as a paint nozzle or a paint spray gun, or a print head; a positioning system 40, such as a vision system with cameras; and an enclosure for some or all of these elements. The artificial covering stone can be for example a brick, a concrete unit, a paving block, an artificial flagstone, etc.

The positioning system 40 allows determining the position of each of the artificial covering stones on the board, or only of the selected stones to be colored. Alternatively, the positioning system 40 can be used to determine the position of the board relative to a reference point and to determine the position of each stone of the board, based on the board layout. The reference point can be for example the reference point of the displacement system. The board layout typically corresponds to the mold used to form the concrete stones. When unmolding the units, it is common that the position of some of the stones slightly differs from its original position in the mold. For example, a stone can deviate in X and Y, or θ (linear and/or angular deviation) from its original position on the board layout. A vision system, for example including a 3D camera, is used to determine the exact position of each stones on the board, thus allowing the system to modify the coloring instructions in order to take into account the real position of the stones on the board. In an embodiment, the vision system also determines a height, length and width for each of the stones and can thus re-adjust the coloring instructions if the dimensions of the stones differ from their predetermined positions.

The coloring tool 38 consists of the tool which will apply color or spray paint on the stones. In an embodiment, the coloring tool is a paint spray gun having a paint nozzle, but a print head can be used instead. The coloring tool also includes the different paint containers, and the tubing for feeding the pain nozzle.

The displacement system 36 allows moving the coloring tool 38 over the artificial covering stones in order to color them. It can consist of a robot able to move the paint nozzle in X, Y and Z directions, allowing the paint nozzle to be moved along 3-dimensional trajectories, each trajectory corresponding to one of the natural stone patterns. The robot can be a six-axis robot, but of course, any other displacement system can be considered, as long as it is able to displace the coloring tool relative to the stones. It can also be considered, for example, to move the entire board of stones while keeping the coloring tool fixed.

The controller 34, which can be the robot's PLC, communicates with the displacement system 36, the coloring system 38 and the positioning system 40. The controller 34 will receive from the coloring software application the coloring parameters, and will use these coloring parameters and the board position to instruct to the displacement system and coloring tool how to move and when to spray, so as to reproduce the natural stone pattern by painting or coloring the artificial covering stones. While it is possible that the displacement and coloring instructions be executed by the processor of the robot's PLC, it is also possible to have a dedicated PLC generating and executing these instructions. It can also be considered to have the coloring instructions generated and stored by the computer running the software application; in such case the software application instructs the PLC the sequence of operation to be executed. Displacing the coloring tool 38 along 3-dimensional trajectories and/or controlling the speed and acceleration of the coloring tool provides a more natural look to the color patterns applied on the stones, since it allows to vary the opacity and texture of the paint layer applied on a selected artificial stone. The coloring device 12 includes several paint containers, with can be pots of paint or cartridges, depending of the type of coloring tool used. The paint contained in the containers can be polymerized by UV rays, which allows setting or curing the paint almost instantly, without affecting the manufacturing cycle time.

The coloring device 12 can work in combination with a conveyor 16, which is part of the manufacturing line for manufacturing the artificial covering stones. The conveyor 16 can include a controller in communication with the controller 34 of the coloring device 12. In the present embodiment, the controller of the conveyor and the controller 34 of the coloring device communicate with one another, so that the conveyor is stopped when the coloring device colors the stones with the natural stone pattern. In another embodiment, it can be considered to use a single controller to control both the conveyor and the coloring device, and/or to adjust the conveying speed of the stones while coloring the stones.

In an embodiment, the coloring system 10 further includes a polymerization station 18. The polymerization station 18 includes UV lamps allowing polymerization of the paint. The conveyor is used to convey the stones in and out of the polymerization station 18. Once the paint has been UV cured and fixed on the stones, they are ready for further processing, such as packaging.

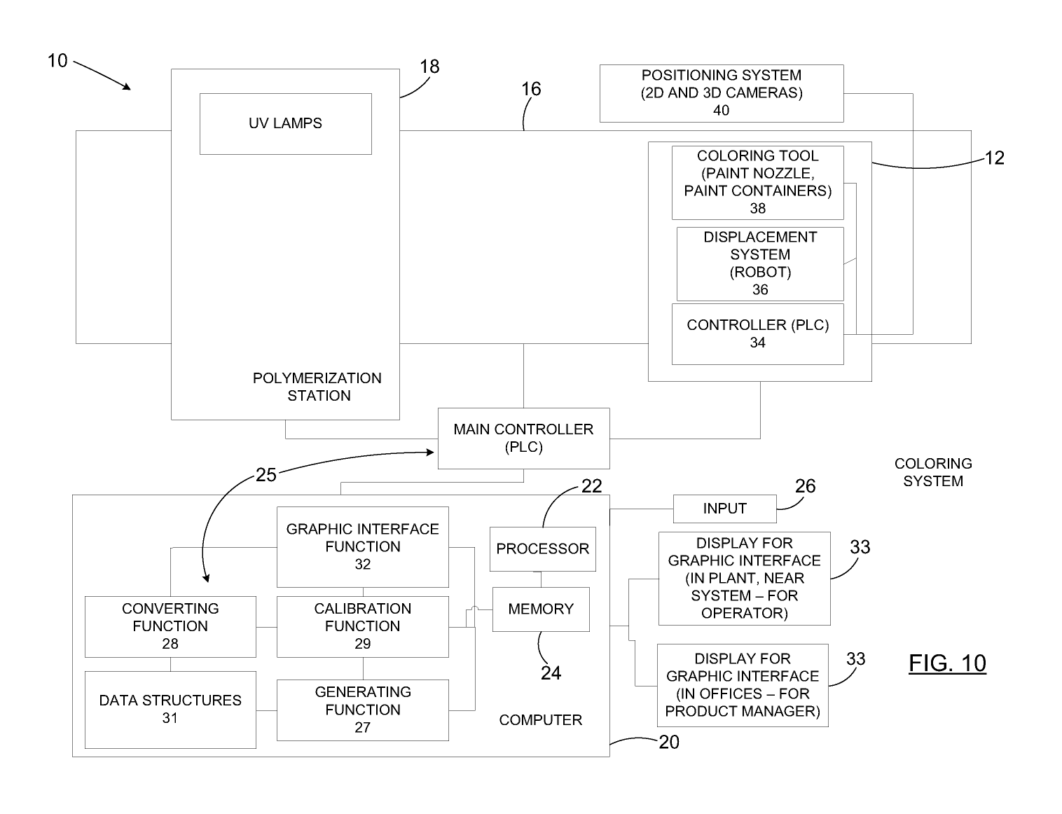

With reference to FIG. 10, another variant of the coloring system 10 is shown. In this variant of the system, the coloring software application and the coloring device are both connected to a main controller 42, which controls both the conveying system 16 and the coloring device 12.

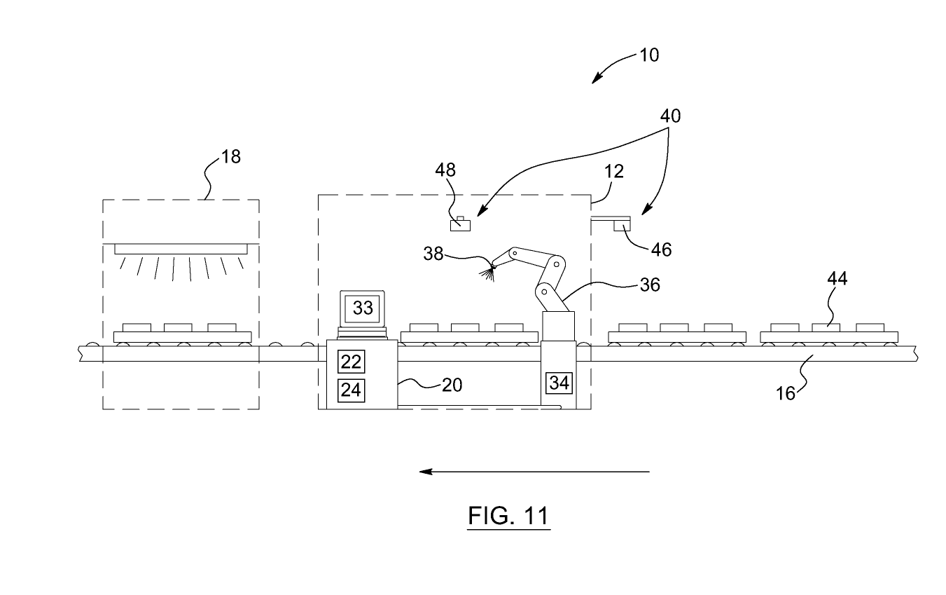

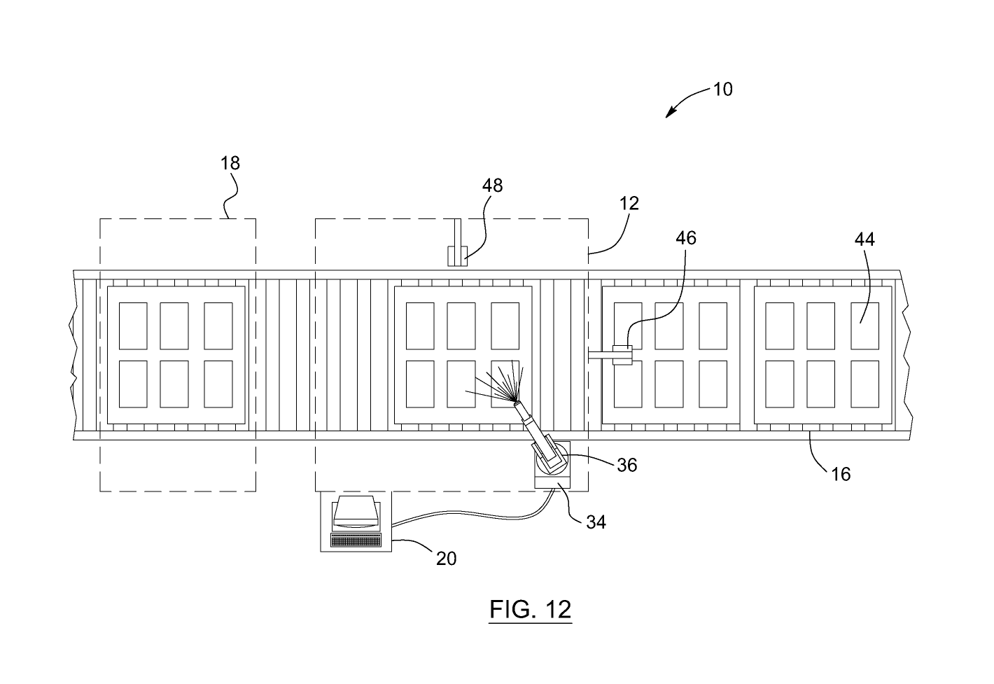

The coloring process will be described with reference to FIGS. 11 and 12, and to FIG. 15. As explained previously, stone color patterns can be created from scratch or selected from a list of pre-existing patterns stored on the memory 24 of the computer 20. The board layout is displayed on a display 33 and a user selects at least some of the stones from the board layout and associates natural stone color patterns with the selected stones. A generating software function part of a software application generates graphic parameters based on the association of patterns and stones conducted previously. A converting software function converts the graphic parameters into coloring instructions. The converting software can be stored on a PLC, or on the computer on which the graphic user interface and the generating software are installed.

The artificial covering stones 44 are conveyed by the conveyor 16, such as on pallets, each pallet supporting several artificial covering stones 44. The covering stones 44 can all be of the same size, or they can be of different sizes. At the entry of the coloring device 12, a positioning system, in this case a 3D camera 46, captures an image of the pallet entering the coloring device 12. The image captured by the 3D camera allows locating each of the stones on the pallet, but also allows obtaining for each unit its precise dimension (height, width and length). This information can then be used by the coloring software application, for example to validate the height of the stones conveyed compared to the height entered manually in the applications.

When entering the coloring device, another positioning element, part of the positioning system 40 (in this case a 2D camera 48) allows to position the artificial stones relative to the a reference point, for example the zero-reference point of the coloring device 12. The positioning system 40, in this case including the 3D and 2D camera, allows determining the exact or real position of each unit on the board, and to position each unit conveyed in the same coordinate system as the robot 36. Alternatively, it is possible to use two 2D cameras, one to image the stones, and another one to locate precisely the position of the pallet within the coloring system. Other positioning systems, for example infrared sensors, can also be considered.

It is worth noting that the images captured by the 2D and 3D cameras can also be used by the coloring software application. They can be used to show to the user the typical layout of the stones for a given type of product, such as shown on the left side of the application window appearing in FIG. 2. They can also be part of the comparing system which allows to validate whether the colored stones are close enough to the reference layout.

The controller 34, which can be the robot's controller, communicates with the computer 20 on which the coloring parameters associated with the natural stone patterns are stored. These coloring parameters are sent to the robot controller, which in turn generates coloring instructions to the robot 36. These coloring instructions instruct the robot of the sequence of displacement to be performed, and simultaneously instruct the coloring tool 38, in this case a spray gun provided with a paint nozzle, on the colors, the displacement speed and the angle of projection to be used. For each line included in a pattern, different coloring instructions are generated. For example, the color to use, the height of the coloring tool relative to the stones, the angle of the projection of the paint, the speed at which the paint must be applied are constantly adjusted during the coloring procedure, until the natural stone pattern previously created through the graphic user interface is entirely reproduced.

For example, in order to create a dense, opaque and thin line on a specific stone, the coloring device will instruct displacement system to place the paint nozzle close to the unit, and instruct the paint nozzle to spray paint at a greater flow rate. On the contrary, moving the paint nozzle far away from the stones will create a more dispersed, shadow-like coloring pattern on the unit.

The robot controller also communicates with the controller of the conveyor so as to adjust the speed at which the stones run through the coloring system. The robot controller can stop the conveyor during the coloring process. Once the coloring is completed, the conveyor 16 conveys the pallets outside the enclosure of the coloring device 12 towards the polymerization station 18, where the paint on the stones can be exposed to UV rays so as to allow its polymerization. The conveyor 16 then conveys the pallets outside the polymerization station 18 towards other sections of the manufacturing line, for example to package the stones 44.

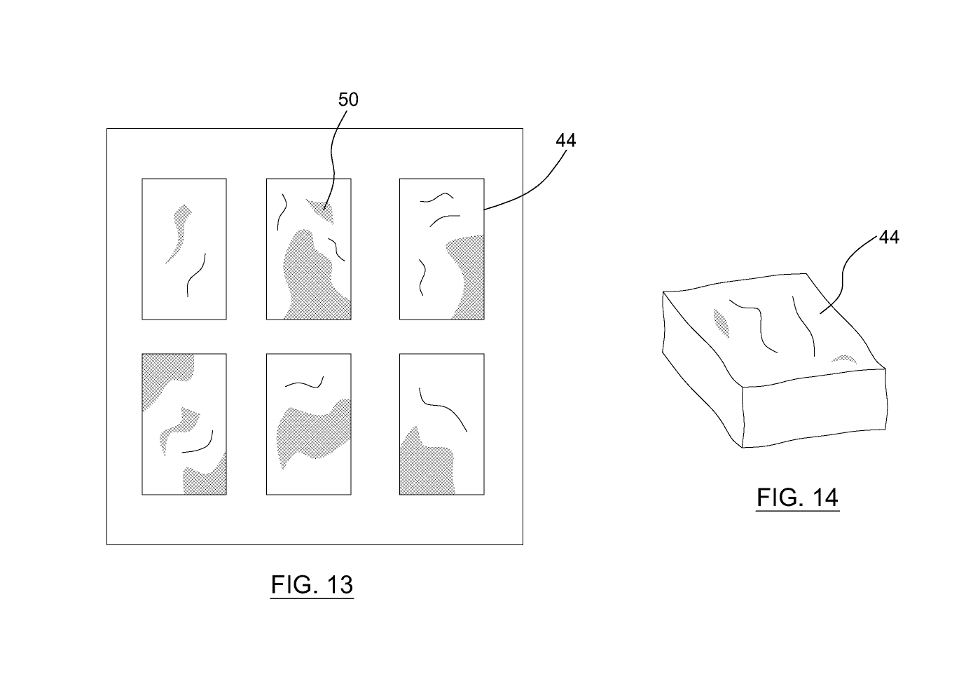

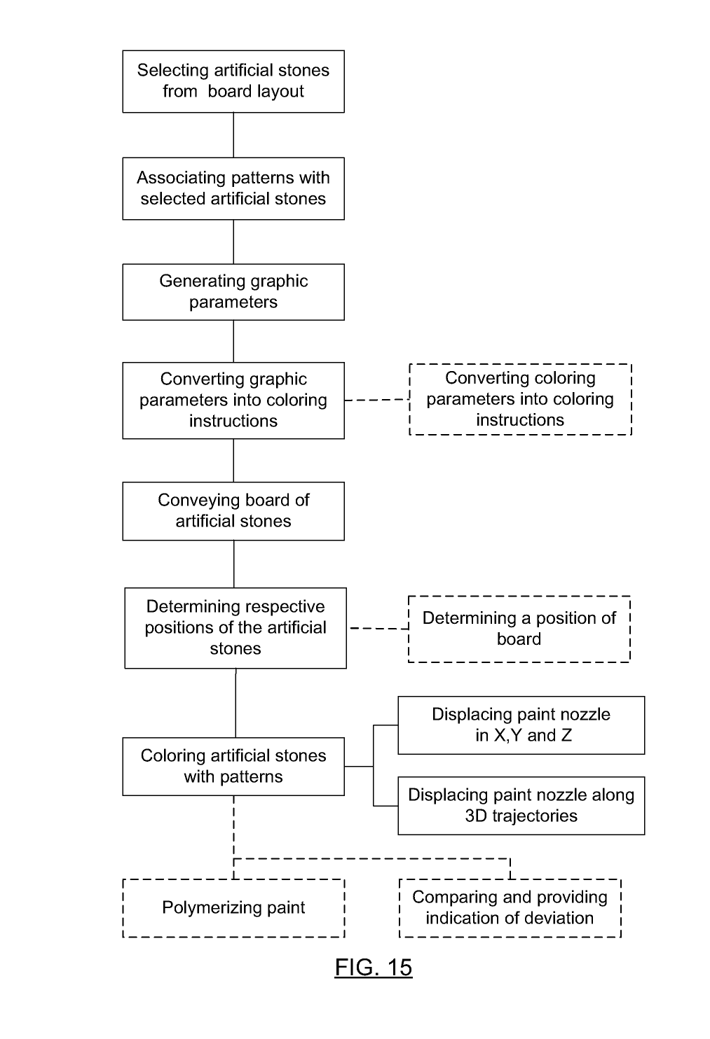

As shown in FIGS. 13 and 14, the stones exiting the coloring system 10 have a natural random look, and in the present case each stone displays different color lines, strokes and shadows forming the natural stone pattern 50. As it can be appreciated, the coloring system of the present invention allows the manufacturing of different, unique stones within the same pallet, but it also allows generating pallets or boards of stones displaying different patterns from one pallet to another. By creating a high number of different patterns and by coloring sequentially these patterns, it is possible to create lots of artificial covering stones in which selected stones are unique and different from the other covering stones of the same lot.

Paint and coloring system generally used in the industry aim at providing a uniform, steady and regular paint coating to the product manufactured, and efforts are placed in having all the stones manufactured identical.

With the present invention, the objective is precisely the opposite, which is to manufacture artificial covering stones where each unit is unique and different from the other stones, although manufactured through the same manufacturing line. The present system also provides the great advantage to handle boards of artificial stones, rather than individually conveyed units. This allows keeping a reasonable manufacturing cycle time. The polymerization station also helps in maintaining a reasonable manufacturing cycle time.

The system and method of the present invention allows manufacturing, through an automated process, artificial covering stones displaying random, unique and natural look patterns. The present invention therefore allows building walls in which repeated pattern on stones is considerably reduced, such that a wall or a surface covered entirely with artificial covering stones produced using these method and system appear to be made of natural stones.

With the present coloring system and method, it is possible to add tones of colors different than the ones used for forming the body of the stones.

It is also possible to enhance the texture of the top face of the artificial stones, for example by projecting the paint at angle relative to the top surface of the units.

In the case of slabs including several artificial bricks or cobbles, spaced apart by deep joints, the present system and method advantageously allows to color individually the exposed face of each of bricks/cobbles with different colors, as it they were made from different colors of clay.

Of course, numerous modifications could be made to the embodiments above.

1. A coloring system for coloring artificial covering stones, the system comprising:
a memory for storing:
a board layout representing a board of artificial covering stones; and
several natural stone color patterns, each of the patterns being different from one another;
a display for displaying the board layout and the natural stone patterns;
an input for receiving instructions to select at least some of the stones of the board layout, and to associate the natural stone color patterns with selected artificial stones of the board layout;
generating means for generating graphic parameters representative of the natural stone color patterns associated with the selected stones of the board layout;
converting means for converting said graphic parameters into coloring instructions;
a conveyor for conveying the board of artificial covering stones;
a positioning system for determining respective positions of the artificial covering stones of the board, relative to a reference position;
an in-line coloring device for coloring the artificial covering stones of the board conveyed by the conveyor with the natural stone patterns, according to the coloring instructions and to the positions of the artificial stones;
the selected artificial stones colored by the system thereby being different from other stones of the board, and having a distinct, natural random-look.

2. The coloring system according to claim 1, wherein said memory contains data representative of at least one of a line, a stroke, a shade and a curve, said natural stone patterns being selected from said data.

3. The coloring system according to claim 1, wherein said input comprises at least one of a keyboard, a tablet, a mouse or a touchscreen.

4. The coloring system according to claim 1, wherein the generating means comprises:
a memory containing a generating software function and a graphic parameter data structure;
a processor, for executing said generating software function and for populating said graphic parameter data structure with the graphic parameters, based on said natural stone color patterns associated with the selected stones of the board layout.

5. The coloring system according to claim 1, wherein said graphic parameter data structure stored on the memory of the generating means contains data representative of at least one of: a color code, a degree of opacity, a degree of transparency, a width, a length, a radius of curvature, a pixel value, a coordinate, and an artificial covering stone identifier.

6. The coloring system according to claim 1, wherein the converting means comprises:
a memory containing a converting software function and a coloring instruction data structure;
a processor, for executing said converting software function and for populating said coloring instructions data structure based on said graphic parameters.

7. The coloring system according to claim 1, wherein the positioning system comprises a vision system for determining the respective positions of the artificial covering stones on the board, and a memory for storing said positions.

8. The coloring system according to claim 7, wherein the processor executes the converting software and populates the coloring instructions data structure based on predetermined coloring parameters associated to the in-line coloring device.

9. The coloring system according to claim 1, wherein the coloring device comprising:
a) a paint nozzle for spraying paint on the artificial covering stones; and
b) a displacement system for displacing the paint nozzle; and
c) a controller for controlling the paint nozzle and the displacement system.

10. The coloring system according to claim 9, wherein said coloring instructions data structure stored on said memory comprises data representative of at least one of: paint cartridge identifiers, an initial position of the paint nozzle when starting to spray, a displacement vector specifying a 3D trajectory to be followed by the paint nozzle, a speed, an acceleration, a number of passes, a flow rate, a pressure, a nozzle angle and a nozzle aperture.

11. The coloring system according to claim 1, wherein the in-line coloring device comprises several paint containers.

12. The coloring system according to claim 11, wherein the paint containers are containers containing paint which is polymerizable by UV rays.

13. The coloring system according to claim 12, further comprising an in-line polymerization station located downstream of the in-line coloring device, for polymerizing the paint applied on the artificial covering stones by the in-line coloring device.

14. The coloring device according to claim 1, further comprising a comparing system, the comparing system including:
means to compare the selected artificial covering stones colored by the coloring device with a reference layout;
means to correlate a deviation thereof; and
an output to emit a signal representative of said deviation.

15. The coloring device according to claim 1, wherein the displacement system is a robot able to move the paint nozzle in X, Y and Z directions.

16. A manufacturing process for coloring selected artificial covering stones, the process comprising the steps of:
a) selecting at least some of the artificial covering stones from a board layout;
b) associating natural stone color patterns, each of the patterns being different from one another, with the selected artificial covering stones selected in step a);
c) generating graphic parameters based on an association performed in step a);
d) converting said graphic parameters of step b) into coloring instructions;
e) conveying the board of artificial covering stones;
f) determining respective positions of the artificial covering stones on the board conveyed in step e) relative to a reference position;
g) coloring in-line the artificial covering stones of the board conveyed in step e) with the respective natural stone patterns, according to the coloring instructions of step d),
thereby providing each of the stones of the board with a distinct, natural random-look, the selected artificial stones colored by the system thereby being different from other stones of the board, and having a distinct, natural random-look.

17. The manufacturing process according to claim 16, wherein the natural stone color patterns of step b) comprises at least one of: a line, a stroke, a shade and a curve.

18. The manufacturing process according to claim 16, wherein step c) comprises populating a graphic parameter data structure with the graphic parameters, based said association of natural stone color patterns with the selected stones of the board layout.

19. The manufacturing process according to claim 16, wherein the graphic parameters generated in step c) comprise at least one of: a color code, a degree of opacity, a degree of transparency, a width, a length, a radius of curvature, a pixel value, a coordinate, an artificial covering stone identifier.

20. The manufacturing process according to claim 16, wherein step d) comprises a step of converting coloring parameters into coloring instructions.

21. The manufacturing process according to claim 16, wherein step f) further comprises a step of determining the respective heights, widths and lengths of the selected artificial covering stones.

22. The manufacturing process according to claim 16, wherein step d) comprises populating a coloring instructions data structure based on the graphic parameters and on the positions of the artificial covering stones.

23. The manufacturing process according to claim 16, wherein step g) comprises a step of displacing a paint nozzle over the board along X, Y and Z directions.

24. The manufacturing process according to claim 16, further comprising a step of polymerizing paint applied in step f).

25. The manufacturing process according to claim 16, further comprising a step of comparing the artificial covering stones colored in step g) with the stones of a reference layout, and providing an indication of the deviation thereof.

26. The manufacturing process according to claim 16, wherein in step g) the paint nozzle is displaced along 3-dimensional trajectories, each trajectory corresponding to one of the natural stone patterns.
